(19) United States
(12) Patent Application Publication
(10) Pub. No.: US 2017/0273004 A1
(43) Pub. Date: Sep. 21, 2017

(54) APPARATUS AND METHOD FOR PERFORMING ROUTING USING SEPARATE PHYSICAL CHANNEL INFORMATION IN MOBILE AD-HOC NETWORK

(71) Applicant: ELECTRONICS AND TELECOMMUNICATIONS RESEARCH INSTITUTE, Daejeon (KR)

(72) Inventors: Tae Joon PARK, Daejeon (KR); Myung Eun KIM, Daejeon (KR); Sun Jin KIM, Daejeon (KR); Myung Nam BAE, Daejeon (KR); Dong Beom SHIN, Daejeon (KR); Hoe Sung YANG, Daejeon (KR); Kang Bok LEE, Daejeon (KR); Sang Yeoun LEE, Daejeon (KR); Hye Sun LEE, Daejeon (KR); Jin Chul CHOI, Daejeon (KR); Sang Gi HONG, Daejeon (KR); Hyo Chan BANG, Daejeon (KR); Jong Hyun PARK, Daejeon (KR)

(73) Assignee: ELECTRONICS AND TELECOMMUNICATIONS RESEARCH INSTITUTE, Daejeon (KR)

(21) Appl. No.: 15/402,364

(22) Filed: Jan. 10, 2017

(30) Foreign Application Priority Data
Mar. 17, 2016 (KR) 10-2016-0032077

(51) Int. Cl. H04W 40/24; H04W 72/04; H04W 40/02

(52) U.S. Cl. CPC H04W 40/248; H04W 40/02; H04W 72/0406; H04W 84/18

(57) ABSTRACT

Provided are an apparatus and method for performing routing for multi-hop communication. A mobile ad-hoc routing apparatus includes a control information manager configured to generate control information for managing a topology in a mobile ad-hoc network, a control information transceiver configured to transmit the control information or information for generating the control information to other nodes and receives control information of the other nodes or information for generating the control information from the other nodes, a data path manager configured to set a path for transmitting and receiving data using the generated control information and the received control information or the information for generating the control information, and a data transceiver configured to transmit and receive the data through the set path. The path for transmitting and receiving the data and a path for transmitting and receiving the control information use channels that are physically different from each other.

### CROSS-REFERENCE TO RELATED APPLICATIONS

This application claims priority under 35 U.S.C. §119 to Korean Patent Application No. 10-2016-0032077, filed on Mar. 17, 2016, the disclosure of which is incorporated herein by reference in its entirety.

### Technical Field

The present invention relates to a system and method for performing mobile ad-hoc routing utilizing a separate channel that is physically separated in order to improve an existing mobile ad-hoc network (MANET) in which only one physical channel is used.

### BACKGROUND

In an environment without the help of communication infrastructure, information for setting a routing path is also transmitted and received only through a data communication channel to maintain communication connectivity because a mobile ad-hoc network (hereinafter also referred to as a MANET) uses only one physical channel. Accordingly, the MANET has many difficulties in maintaining a routing path because of data path disruption that has frequently occurred in this case. In order to overcome such difficulties, many efforts are being made, but there are fundamental limitations due to properties caused by using one physical channel.

MANET technology is suitable to autonomously maintain communication connectivity even in an environment without the help of existing communication infrastructure, for example, a disaster site, a wild site, a military operation area, etc.

Autonomous communication connectivity using the MANET technology may be maintained through a multi-hop communication path between nodes that are well managed. The multi-hop communication path is determined based on a topology that describes communication properties between the nodes. Accordingly, the properties and performance of the MANET are closely associated with a method of reflecting a change in topology due to movement of the nodes.

Typical MANET routing determines a routing path in consideration of an initial node topology. Subsequently, a change in node topology due to movement of communication nodes is reflected in the routing path. FIG. 4 shows setting of a routing path according to such a related art. Here, information about nodes that are located outside the coverage of a data network is not managed.

However, when data is attempted to be transferred through an existing routing path while a node topology changed according to the movement of the communication modes is not reflected in the routing path, the data transfer will fail due to data path disruption caused by the movement of the nodes. Accordingly, the reflection of the change in node topology in the routing path in time is an important element that directly affects stability of the MANET technology. Various methods associated with this element have been proposed in the related art.

Two representative methods are a reactive protocol method that finds path setting information when a communication request is made and a proactive protocol method that continuously finds the path setting information at a certain interval, irrespective of the communication request.

The reactive protocol method has difficulties in that data is lost due to the movement of the node or data transmission is delayed by a time taken to find the movement of the node.

The proactive protocol method has no delay to find the movement of the node because the path setting information is continuously found at a certain interval. However, the proactive protocol method has difficulties in that a path error has occurred and data is lost because the change in node cannot be found when the interval is too long, and a load for finding the path increases when the interval is too short.

The above-described topology management method has been proposed due to these difficulties, but has difficulties in that topology management information for recovering a data transfer channel having a problem should be transmitted or received through the data transfer channel because only one physical channel is used. The difficulties in managing the topology according to characteristics of the moving nodes have not been overcome due to such inefficiency, and thus the MANET technology has not widely been used.

### SUMMARY

The present invention has been made based on technical background as described above. In addition, the present invention proposes the use of a physically separate channel to manage a topology for management of a routing path, which is essential for effectively operating the MANET that autonomously maintains communication connectivity in an environment with no communication infrastructure, and also provides a system and method for managing the topology by exchanging information through this separate channel and performing location-based routing.

The present invention is not limited to the above objectives, but other objectives not described herein may be clearly understood by those skilled in the art from descriptions below.

In one general aspect, a mobile ad-hoc routing apparatus is characterized by using two or more different channels that are physically separated as the path for transmitting and receiving the data and the path for transmitting and receiving the control information. As an example, the mobile ad-hoc routing apparatus includes: a control information manager configured to generate control information utilizing a variety of information such as location information, received-signal strength, etc. for managing a topology in a mobile ad-hoc network; a control information transceiver configured to transmit the control information to other nodes and receive control information of the other nodes from the other nodes; a data path manager configured to set a path for transmitting and receiving data using the generated control information and the received control information; and a data transceiver configured to transmit and receive data through the set path. The path for transmitting and receiving the data and the path for transmitting and receiving the control information use different channels that are physically separated.

In another general aspect, a mobile ad-hoc routing method includes generating control information utilizing a variety of information such as location information, received-signal strength, etc. for managing a topology in a mobile ad-hoc network; transmitting the control information to other nodes and receiving control information of the other nodes from the other nodes; setting a path for transmitting and receiving data using the generated control information and the received control information; and transmitting and receiving data through the set path. The path for transmitting and receiving the data and the path for transmitting and receiving the control information use different channels that are physically separated.

Other features and aspects will be apparent from the following detailed description, the drawings, and the claims.

### BRIEF DESCRIPTION OF THE DRAWINGS

FIG. 1 is a block diagram showing a routing apparatus according to an embodiment of the present invention.

FIG. 2 is a diagram schematically showing a change in path settings according to an embodiment of the present invention.

FIG. 3 is a flowchart showing a location-based routing method according to another embodiment of the present invention.

FIG. 4 is a diagram schematically showing a change in path settings according to the related art.

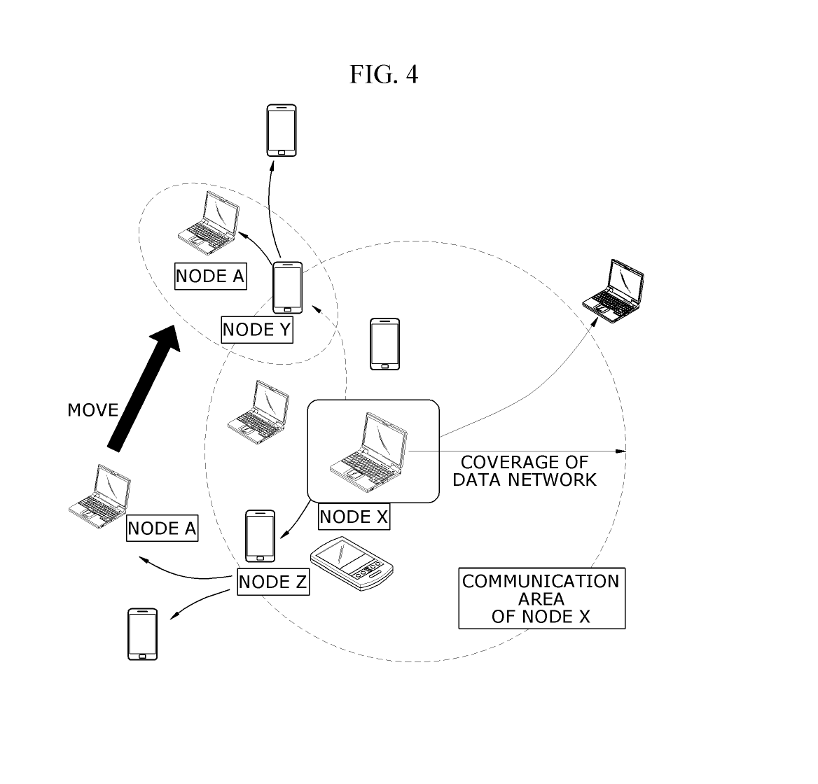

### DETAILED DESCRIPTION OF EMBODIMENTS

Hereinafter, embodiments of the present invention will be described in detail with reference to the accompanying drawings.

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this invention will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings.

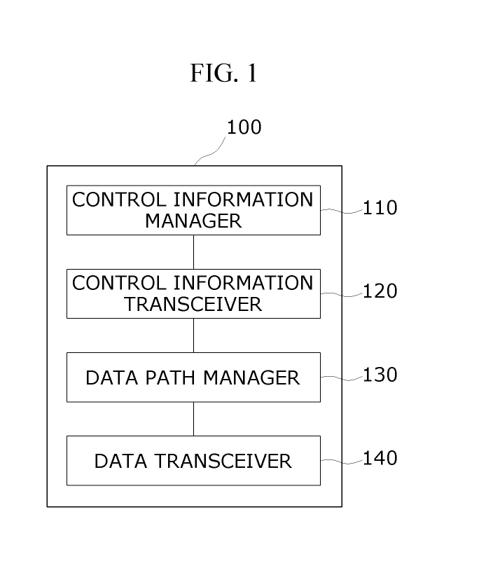

FIG. 1 is a block diagram showing a routing apparatus 100 according to an embodiment of the present invention.

A core concept of the present invention is to use channels that are physically separated as a communication channel for transferring data and a communication channel for transmitting or receiving control information of each node to set a communication path in order to maintain a stable communication path.

For this, the routing apparatus 100 includes a control information manager 110, a control information transceiver 120, a data path manager 130, and a data transceiver 140.

The control information manager 110 generates control information, which is basic information for survival management of a user, such as a position, a moving speed and direction, and received-signal strength of the routing apparatus 100, and manages the generated control information in addition to control information received from other nodes.

The control information transceiver 120 serves to broadcast the control information generated by the control information manager 110 to nearby nodes and receive control information broadcast by the nearby nodes. The control information has a small amount of information, but requires stability and reliability of connection and is capable of remote communication. Accordingly, the control information is transmitted or received using a Sub-GHz band channel, which is a low-speed channel that may communicate at a greater distance than a data communication channel.

The data path manager 130 serves to set a path for transmitting data, find control information of nodes that are changing, and change or maintain the path using the generated and collected control information.

Basically, the data path manager 130 finds nodes that are located within a distance in which the control information or data may be transmitted or received using location information and generates and manages a topology for multi-hop communication with reference to a moving speed and direction of each of the nodes.

For example, basically, the data path manager 130 determines nodes that are located within a data transmission or reception region of the routing apparatus 100 and have the best connection status on the basis of location information and sets a path. However, when it is determined that a node will soon move out of the data transmission or reception region in consideration of a moving speed and direction of the node, the data path manager 130 may set a path for hop communication with the remaining nodes, except for the node.

In addition, the control information is transmitted or received through a Sub-GHz band channel, which is at a relatively low speed and has stability and reliability and is capable of relatively remote communication. Accordingly, the data path manager 130 serves to find and manage locations, moving directions, and speeds of a node to be connected and a node serving as a repeater for multi-hop communication in advance such that an optimal path to a destination node is always maintained.

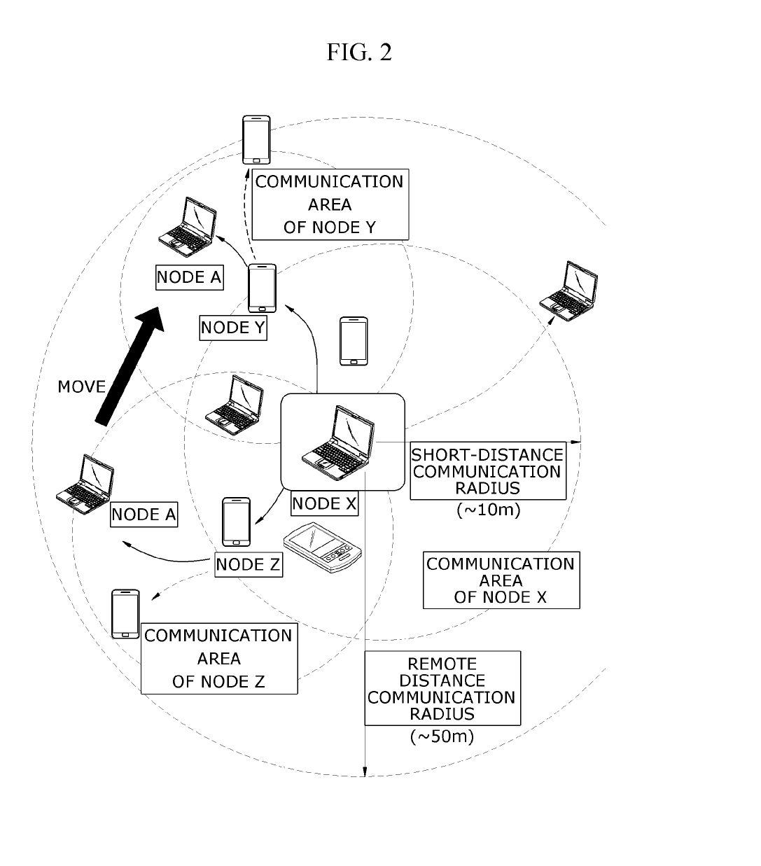

FIG. 2 is a diagram schematically showing that the data path manager 130 sets and changes a data path to a destination node. A short distance communication radius indicates a radius in which data communication may be performed, and a remote distance communication radius indicates a radius in which the control information may be transmitted or received.

The short-distance communication is a communication scheme, such as Wireless Fidelity (WiFi), that may transmit and receive a large amount of data at a high speed within a relatively short distance of approximately 10 meters, and the remote-distance communication is a communication scheme used to remotely and stably transmit a small amount of data between nodes located within a relatively long distance of approximately 50 meters, compared to the short-distance communication.

In order for multi-hop communication between initial node X and node A, the data path manager 130 of node X finds nodes located within a region in which a short-distance high-speed wireless communication may be made with node X and sets a path for data communication with node A via node Z, which is an optimal communication path.

Subsequently, the data path manager 130 collects locations, speeds, or directions of nodes within the remote distance communication radius in which the control information may be transmitted or received, and finds movement of node Z and movement of node A on the basis of the collected information. When node Z moves outside a short distance communication radius of node X, node X resets a path to node A via node Y using such information, and thus a communication path to node A may be stably maintained.

In detail, a method of resetting connection between node X and node A is as follows.

When MANET connection is disconnected between node X and node A, node X and node A find nodes within the remote distance communication radius. Control information is received from the nodes in the remote distance communication radius, and each of the nodes finds which nodes are located within a range in which connection may be made through the short-distance communication.

Node A, node Y, and node Z are located in a remote distance communication radius of node X, and node Y is located in a short distance communication radius of node X. Node Y, node Z, and node X are located in a remote distance communication radius of node A, and node Y is located in a short distance communication radius of node A. Thus, as a result, node X and node A reset the MANET connection through node Y.

In this case, since a channel through which the control information is transmitted or received in the remote distance communication radius and a channel through which data is transmitted or received in the short distance communication radius are physically separated, communication is efficiently performed without any interference.

The data transceiver 140 transmits or receives data needed through multi-hop connection or direct connection using a data path that is generated in this way.

The data transceiver 140 transmits or receives a large amount of data to or from nodes that are located in a short distance from the routing apparatus 100 and thus are capable of GHz band communication at a high speed using WiFi communication or visible light communication that may be utilized for high-speed large-scale communication.

In addition, a Bluetooth or ZigBee communication method may be used for a short distance, and an existing mobile communication network such as third generation (3G) or long term evolution (LTE) may be used for a remote distance. The Bluetooth or ZigBee communication method has a low transfer speed, but may be implemented at low complexity and low power.

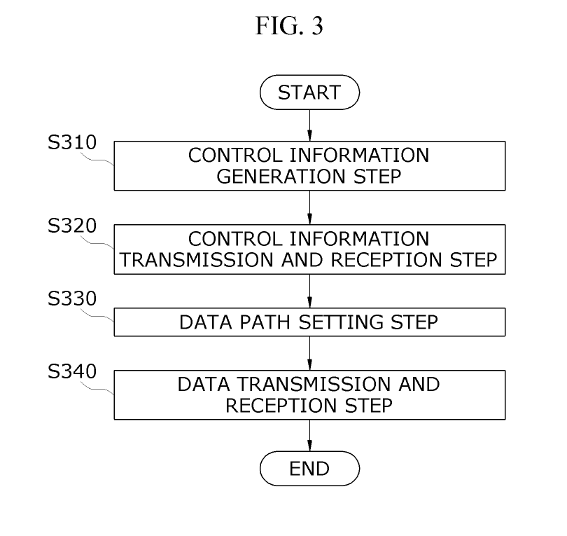

FIG. 3 shows a flowchart of a routing method according to an embodiment of the present invention.

In a control information generation step S310, control information such as a location, a moving direction, and a speed of a node is generated and managed.

In a control information transmission and reception step S320, the control information generated in the control information generation step S310 is broadcast to nearby nodes through a stable channel capable of remote communication, and also control information transmitted from the nearby nodes are received.

In a data path setting step S330, an optimal path capable of high-speed large-scale communication is set using the collected control information, and the path is reset according to a variation of each node.

Last, in a data transmission and reception step S340, data communication is performed using a predetermined multi-hop data path or a direct path. Here, the data path uses a channel that is physically different from that of a path for transmitting or receiving the control information.

Data transmission or reception requires a high-speed large-scale data exchange, and thus WiFi communication, visible light communication, etc. may be used. In addition, a wireless communication scheme such as Bluetooth or Zigbee, which may be implemented at low complexity or low power, may be used, and an existing mobile communication network such as 3G or LTE may also be used.

By transmitting and receiving control information used to set a path and data to be actually exchanged using a physically separate channel, it is possible to use a stable channel capable of remote communication when the control information is exchanged and use a channel capable of transmitting and receiving high-speed large scale information when the data is exchanged, thus increasing efficiency of data transfer and reliability of network connection.

According to the present invention, it is possible to separately manage a change in topology capable of communication of a data transfer channel according to the movement of a communication target node in an environment in which there is no communication infrastructure and workers move freely, continuously maintain communication connectivity for the data transfer, and effectively manage the change in topology according to the movement of the node, thus increasing reliability of network connectivity.

Also, the present invention may be utilized in industries where communication infrastructure is lost or difficult to install such as plants, constructions, or chemicals, a worker safety field, and various autonomous communication services for general users which are growing rapidly in recent years.

While the configuration of the present invention has been particularly shown and described with reference to the appending drawings and preferred embodiments, it will be understood by those of ordinary skill in the art that various changes in form and details may be made therein without departing from the spirit and scope of the present invention. Accordingly, the technical scope of the present invention should not be limited to the above-described embodiments, but be determined only by the technical concept of the appended claims.

What is claimed is:

1. A mobile ad-hoc routing apparatus comprising:
a control information manager configured to generate control information for setting a path in a mobile ad-hoc network;
a control information transceiver configured to transmit the control information or information for generating the control information to other nodes and receives control information of the other nodes or information for generating the control information from the other nodes;
a data path manager configured to set a path for transmitting and receiving data using the generated control information and the received control information or the information for generating the control information; and
a data transceiver configured to transmit and receive the data through the set path for transmitting and receiving the data, wherein
the path for transmitting and receiving the data and a path for transmitting and receiving the control information use channels that are physically different from each other.

2. The mobile ad-hoc routing apparatus of claim 1, wherein the information for generating the control information includes at least one or more of location information, moving speeds, moving directions, and received-signal strength of the nodes.

3. The mobile ad-hoc routing apparatus of claim 1, wherein the data transceiver transmits and receives the data in a Wi-Fi, Bluetooth, mobile communication, ZigBee, or visual light communication method.

4. A mobile ad-hoc communication method using a mobile ad-hoc network (MANET), the mobile ad-hoc communication method comprising:
transmitting and receiving control information for setting a communication path of the MANET to set a communication path; and
transmitting and receiving user data through the set communication path, wherein
the user data and the control information are transmitted and received using physically separated channels.

5. The mobile ad-hoc communication method of claim 4, wherein the setting of the communication path comprises:
generating the control information for managing the communication path in the mobile ad-hoc network;
transmitting the control information or information for generating the control information to other nodes, and receiving control information of the other nodes or information for generating the control information from the other nodes; and
setting a path for transmitting and receiving data using the generated control information and the received control information or the information for generating the control information.

6. The mobile ad-hoc communication method of claim 5, wherein the information for generating the control information includes at least one or more of location information, moving speeds, moving directions, and received-signal strength of the nodes.

7. The mobile ad-hoc communication method of claim 5, wherein the transmitting and receiving of the data comprises transmitting and receiving the data in a Wi-Fi, Bluetooth, mobile communication, ZigBee, or visual light communication method.

8. The mobile ad-hoc communication method of claim 4, wherein the setting of the communication path comprises using a communication scheme capable of remote communication rather than a communication scheme used in the transmitting and receiving of the user data.

9. The mobile ad-hoc communication method of claim 4, further comprising, after the transmitting and receiving of the user data:
when the set communication path is disrupted, transmitting and receiving control information for setting the communication path to and from nearby nodes at a node in which the communication path is disrupted;
finding a node to or from which user data is transmitted or received as the disrupted node using the received control information; and
setting a communication path between disrupted nodes using the nodes at which the user data is transmitted or received in order to reset the disrupted communication path.
